(19) United States
(12) Patent Application Publication
(10) Pub. No.: US 2006/0274659 A1
(43) Pub. Date: Dec. 7, 2006

(54) Method and system for generating synthetic digital network traffic

(75) Inventor: Steven J. Ouderkirk, West Richland, WA (US)

Correspondence Address: BATTELLE MEMORIAL INSTITUTE;ATTN: IP SERVICES, K1-53, P. O. BOX 999, RICHLAND, WA, 99352, US

(73) Assignee: Battelle Memorial Institute, Richland, WA (US)

(21) Appl. No.: 11/124,067

(22) Filed: May 6, 2005

(51) Int. Cl. H04J 3/14; H04J 1/16; H04L 1/00; H04L 12/26; H04L 12/16; H04Q 11/00

(52) U.S. Cl. 370/241

(57) ABSTRACT

Embodiments of the present invention encompass a method and a system for generating synthetic network traffic. The synthetic network traffic can be utilized for information operations, information assurance, and information exploitation. The method comprises the steps of providing a behavior model to an agent through a controller, operating the agent on a host, and exchanging data between a server and the agent, wherein the agent stochastically generates network traffic based on the behavior model. The system comprises an agent operating on a host, wherein the agent stochastically generates network traffic based on a behavior model. A server exchanges data with the agent, and a controller provides the behavior model to the agent. In one

[symbol]

### STATEMENT REGARDING FEDERALLY SPONSORED RESEARCH OR DEVELOPMENT

This invention was made with Government support under Contract DE-AC0576RLO1830 awarded by the U.S. Department of Energy. The Government has certain rights in the invention.

### SUMMARY

Embodiments of the present invention encompass a method and a system for generating synthetic digital network traffic. The synthetic network traffic can comprise bi-directional, high-volume traffic utilizing multiple protocols and can be indistinguishable from “live” traffic. As described below, the synthetic traffic can be free of undesirable content and can be reproduced to validate test results. Applications can include, but are not limited to, information operations, information assurance, and information exploitation. Specific applications can include, but are not limited to, cyber security and/or network training, testing, and tuning. Thus, embodiments of the present invention can provide a realistic simulation of the internet via software. The synthetic network traffic can have little, or no, anomalous traffic that might be detected by analytical tools, intrusion detection systems, and/or network or host-based firewalls.

The method comprises the steps of providing a behavior model to an agent through a controller, operating the agent on a host, and exchanging data between a server and the agent, wherein the agent stochastically generates digital network traffic based on the behavior model. The system comprises an agent operating on a host, wherein the agent stochastically generates network traffic based on a behavior model. A server exchanges data with the agent, and a controller provides the behavior model to the agent. In one embodiment, the synthetic network traffic can be generated in an isolated network.

In some embodiments, operating the agent can further comprise providing a simulation delta-time and calculating whether an activity occurs during the simulation delta-time. In calculating whether an activity occurs or not, the agent can use an activity-probability function for each activity and a pseudo-random number generator. If the activity occurs, then the exchanging data step can further comprise selecting a server for a particular event, establishing a link to the server, transferring data between the server and an actor, and terminating the link. Otherwise, the simulation delta-time is incremented and a new determination is made regarding the occurrence of an activity. Typically, the calculation is repeated for each incremented simulation delta-time while the elapsed time is approximately less than a predetermined total simulation time.

Activities can comprise at least one event and can be executed by an actor. Furthermore, each actor can perform at least one activity and belongs to an actor class. Performance of multiple activities by the actor can be substantially simultaneous. Actor classes typically comprise a behavior model having at least one activity profile, which can specify operational schedules, activities, operational capabilities, activity-probability functions, or combinations thereof. An operational schedule can specify the timing and duration of activities performed by the actor. Activity-probability functions can comprise probability definitions for mean and standard-deviation events per simulation delta-time and help determine whether a particular activity occurs. Therefore, details regarding if and when particular activities are performed by the actors can depend on the actor's behavior model and respective actor class.

Typically, actors comprise instantiations of actor classes and a community comprises a plurality of actors. In one embodiment, actor classes are defined deterministically, while actor instantiation can be stochastic. Furthermore, activities can be performed according to a stochastic activity profile.

Data exchanged between agents and servers can vary in size and are not limited to a fixed value, but can be infinite. An example of infinite data is a web stream such as Internet radio broadcasts wherein the length of the data flow and, therefore the total size, is indefinite. The data can be random, static, accessed arbitrarily from a predefined data set, dynamically generated or it can be a combination thereof. Random data comprises unintelligible data. The data can further comprise controlled content, which can allow the presence of undesirable data such as malware and/or sensitive information to be regulated. Addition of this undesirable data for purposes of testing, tuning, and/or training can be provided by other means such as real users or automated hacking tools. Servers can be real or they can be emulated.

The synthetic network traffic can be generated on a network comprising a serial network. More specifically, network traffic generation can occur on an Ethernet, a wireless network, or a combination thereof. Furthermore, it can utilize protocols that include, but are not limited to, supervisory control and data acquisition (SCADA), hyper-text transfer protocol (HTTP), simple mail transfer protocol (SMTP), transmission control protocol/internet protocol (TCP/IP), and combinations thereof. Specific instances of SCADA include, but are not limited to Modbus, Distributed Network Protocol Version 3.0 (DNP3), Conitel, IEC 60870-5-101 and RP-570 and combinations thereof.

With respect to architecture, hosts can comprise at least one agent and can be managed by a controller. In some embodiments, traffic metrics are collected through the agent, which metrics are transmitted to the controller. Management of the synthetic network traffic generation can occur on a different subnet than that on which the synthetic network traffic is generated. Furthermore, the clock for the simulation can be independent from that of the hosts on which the simulation is running.

### DESCRIPTION OF DRAWINGS

Embodiments of the invention are described below with reference to the following accompanying drawings.

FIG. 1 is a diagram depicting the architecture of an embodiment of the synthetic network traffic generator.

FIG. 2 is a diagram depicting an embodiment of the synthetic network traffic generator and a variety of servers.

FIG. 3 is a flowchart illustrating an embodiment of the method for generating synthetic network traffic.

FIG. 4 shows an embodiment of an activity profile.

FIG. 5 is a flowchart illustrating an embodiment of an actor exchanging data with a server.

### DETAILED DESCRIPTION

As used herein, a host can refer to a networked system that hosts at least one agent.

An agent can refer to a program, or a component of a program that runs a simulation and generates synthetic digital traffic. In the context of a client-server model, the agent can provide the server function wherein the client is the controller.

As used herein, actor can refer to a simulated user and comprises an instantiation of an actor class. Instances of actors can include, but are not limited to virtual persons, virtual devices, a sensor, an actuator, or combinations thereof.

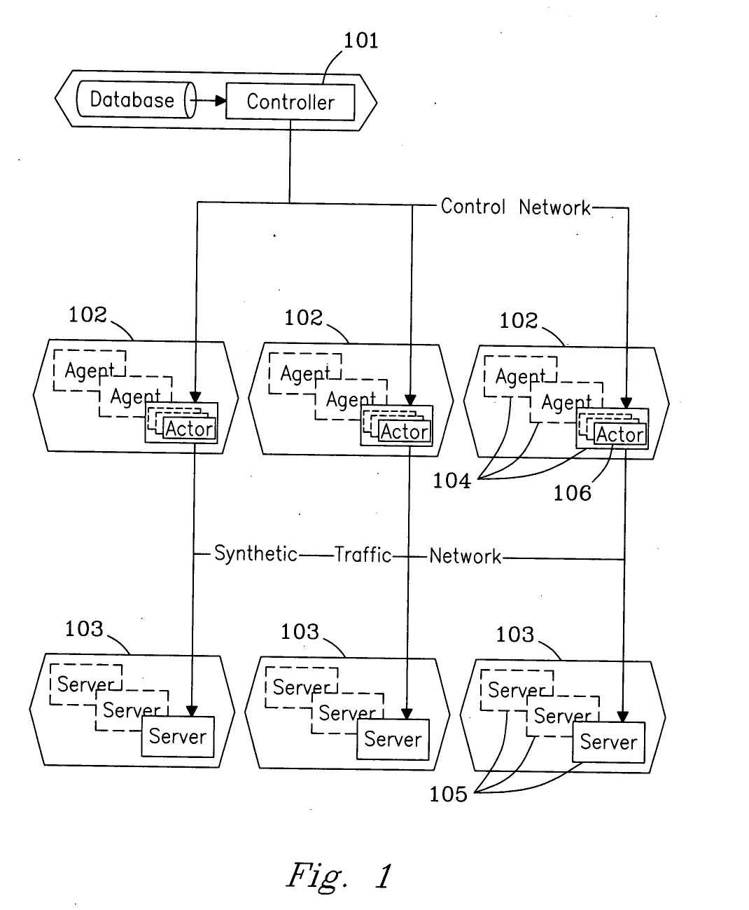

A system for generating synthetic network traffic comprises at least one agent operating on at least one host. Referring to the embodiment depicted in FIG. 1, the system can further comprise a controller 101 that manages a plurality of the hosts 102. The system can be scaled by adding hosts and agents. Thus, the amount of synthetic traffic being generated is limited by the provided hardware. The controller can be used to create behavior models that specify the stochastic behavior of actor classes and/or actors. The controller can further define the hosts on which agents are operational and distribute behavior models to agents, thereby instantiating an actor. Yet another function of the controller can be initiation of synthetic network-traffic-generation sessions by activation of all the appropriate agents. As indicated in FIG. 1, the control data can be separate from the generated synthetic traffic through the use of a sub-net.

Each host 102 comprises at least one agent 104, which agents comprise at least one actor 106. Agents can serve to determine whether an actor will perform a particular activity at a given simulation time according to the actor's behavior model. Therefore, the agent stochastically generates network traffic according to the behavior model of its actors. When it is determined that an actor should execute an activity, the actor, through its respective agent, can then initiate network sessions with servers 105, which serve the network session request, resulting in the exchange of data between the server and the agent. Furthermore, the agents can be used to collect traffic metrics as the synthetic network traffic is generated.

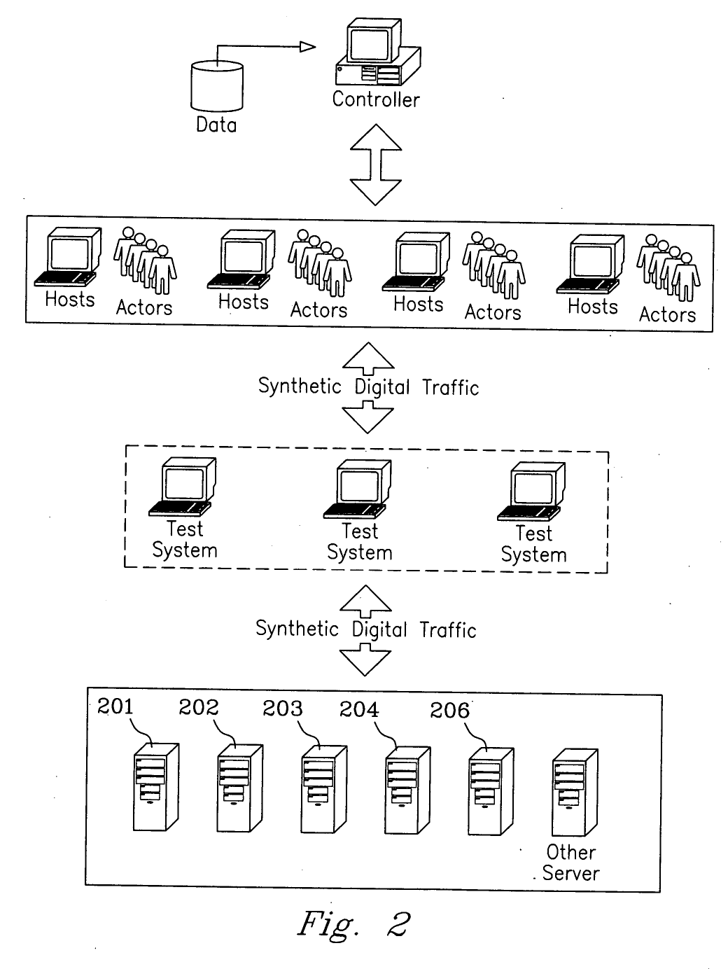

As depicted in FIG. 2, servers can include, but are not limited to, telnet servers 201, SMTP servers 202, FTP servers 203, chat servers 206, and/or web servers 204. The servers can be real or they can be emulated. An example of a real server comprises an Apache server.

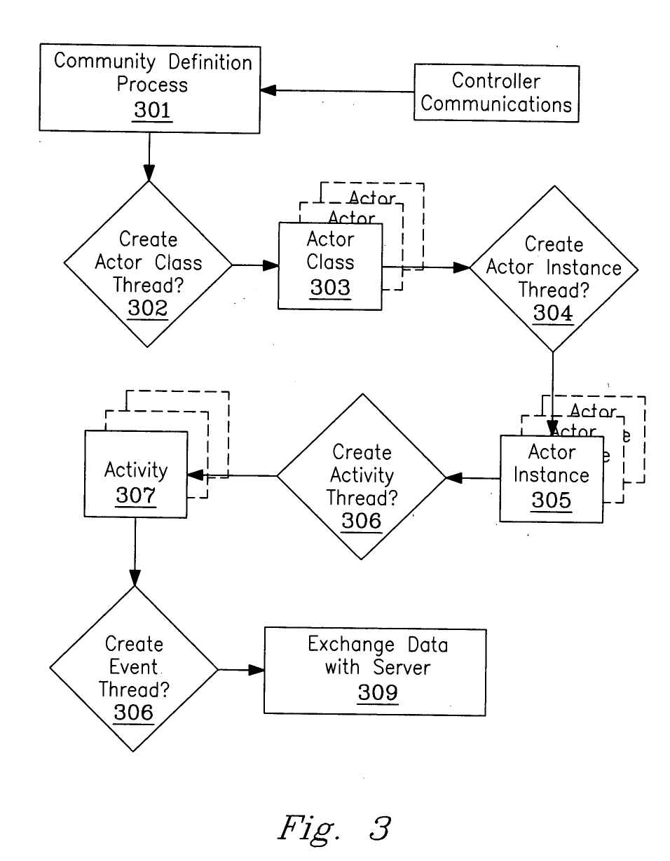

Referring to FIG. 3, generating synthetic network traffic can comprise populating the agents, which run on hosts, with actors. Thus, a user, through the controller, can orchestrate a community definition process 301 by creating at least one actor class thread 302. An actor class 303 comprises a behavior model and is associated with a category of actors. The behavior model can comprise a name and a set of at least one activity profile, which set can be used to distinguish one actor class from another. For example, each actor class can have a unique behavior model specifying the types of activities to be performed, as well as the time and duration for performing it. Thus, instances of actor classes might include managers, scientists, engineers, administrative assistants, and technicians; each of which can have different simulated tendencies with respect to their usage of the web, email, and ftp, for example.

Once the actor classes are established, one or more actors are created to run as threads 304 on each of the hosted agents defined for the simulation environment. In populating the simulation community, instantiation of the actors from actor classes can be stochastic or deterministic. Each actor 305 can be given a unique identifier and can be substantially the same as any other actors of a particular actor class or, alternatively, each actor in an actor class can be slightly modified at the time of instantiation. The agent, on which an actor resides, can stochastically calculate whether or not a specific activity occurs 306 during a particular simulation time based upon the actors behavior model and activity profiles.

While a behavior model can comprise a list of activities associated with the particular actor and/or actor class, an activity profile specifies events, an event-volume mean, an event-volume standard deviation, an absolute target, and/or a target class from which a specific target can be selected during the simulation. Therefore, an activity can include, but is not limited to, email, web surfing, transferring files via FTP, or chatting. An event can refer to specific actions associated with a given activity. For example, downloading a specific website is an event associated with web surfing.

When an activity thread is instantiated 307, as determined by the agent, an event thread can be created 308, which determines the specific action to be performed by the actor. Assuming an activity is to occur during a particular simulation time, the actor can create at least one event thread 308 and exchange data with a server 309. Furthermore, each actor 305 can execute a plurality of activities 307 substantially simultaneously. This can serve to simulate a person that, for example, is receiving a web stream while sending an email.

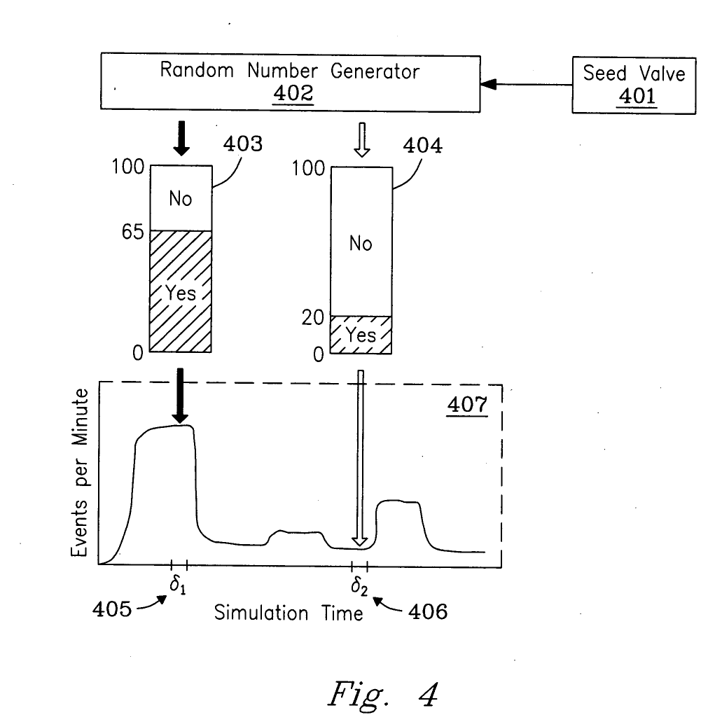

As mentioned previously, operating the agent can comprise determining whether an actor performs an activity at a particular simulation time. Referring to the embodiment depicted in FIG. 4, a seed value 401 is provided to a random number generator 402, which can be used with behavior statistics to determine if an activity occurs during a particular simulation delta-time. In the instant embodiment, the behavior statistics are associated with the activity profile 407 and comprise activity probabilities, 403 and 404, as a function of the simulation time. The activity probability functions at simulation delta-times, δ₁ 405 and δ₂ 406, are shown as bar graphs 403 and 404, respectively. Simulation delta-times comprise increments of simulation time during which activity probability calculations are performed and can range from sub-second to minutes. From the seed value, the pseudo-random number generator can produce a number, for example, between 0 and 100. The output can be compared to the activity-probability function. Using the function at δ₁ 405, for instance, any output from the number generator that is less than 65 indicates that the activity occurs and, therefore, the actor will execute the appropriate action. Similarly, at δ₂ 406, any output greater than 20 would indicate that no activity occurs and the actor would remain idle with respect to the instant activity. The numeric values provided in the present example are for illustrative purposes and are not intended to limit the scope of the present invention. In both cases, instantiation of the activity correlates with the activity profile 407, which can be represented as a plot of events per minute as a function of simulation time.

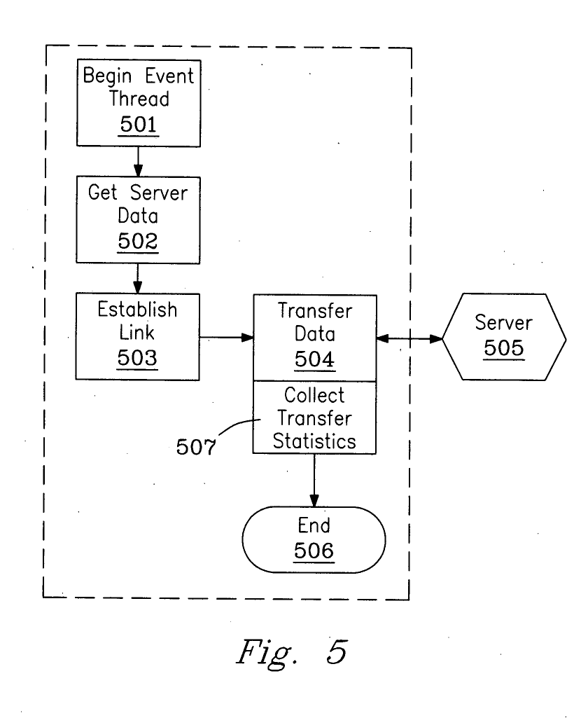

When it has been determined that an activity occurs during a simulation delta-time, an event thread is created and data is exchanged with a server. Referring to the embodiment depicted in FIG. 5, the event thread begins 501 with a process to retrieve server data 502. Through its respective agent, an actor establishes a link 503 to the appropriate server, which is determined by the type of activity at hand. Data is exchanged 504 between the actor and the server 505. The respective agent can collect transfer statistics comprising traffic metrics 507. When the event is complete, the link is terminated and the event ends 506.

The simulation time can be incremented and the agent can determine which activities will occur according to the activity profiles. In some embodiments, the simulation can continue until the elapsed simulation time is approximately equal to the total simulation time. For example, synthetic network traffic might be simulated according to embodiments of the present invention for a total simulation time of one week. The simulation time can run from 6 am to 10 pm on Monday through Friday, and 10 am to 4 pm on Saturday and Sunday. The simulation delta-time might increment through each day in increments of 1 second. When the simulation delta-time reaches Sunday at 4 pm, the simulation would end and synthetic network traffic generation would cease. In one embodiment, the simulation clock is independent of the host system clock. In the case of multiple hosts, the simulation clocks among all agents can be synchronized.

Example—TrafficBot Synthetic Network Traffic Generator

Architecturally, the synthetic network traffic generator of the instant example, TrafficBot, comprises a controller, a WINDOWS® agent, and a LINUX® agent. The use of multiple platforms, in this case, WINDOWS® and LINUX®, is encompassed by an embodiment of the present invention. The TrafficBot Controller can be a graphical application providing the tools to create actor classes and their associated behavior models. It can further define the systems where TrafficBot agents are operational, define the distribution of actor classes to the agents, and specify the stochastic behavior of the actors.

According to the present embodiment, the controller can comprise two data structures. An agent list can detail the connection between an agent's name, port number, and IP address. An actor list can contain information about the actor's name, the respective actor class/behavior model, status, and agent host. The data structures described above can be stored in a structured query language (SQL) database, which can further comprise agent system data, actor data, activity profile data, and simulation engine data. Agent system data can include, but is not limited to operating system specifications. The actor data can describe the name, host, behavior model, and seed values relevant to a particular actor. The activity profile data can comprise activity names and stochastic behavior data. The simulation engine data can comprise a name and simulation parameters such as the simulation time.

A communication protocol can serve to transfer data between the controller and the agents. Messages can consist of an integer control code, an integer length field, and additional data. The control code determines the type of data that will follow and, therefore, how the agent will respond. The agents will be required to respond to each message (request) from the controller for verification. In this way, a variety of information transfers (e.g., data/code serialization) can be performed reliably.

The messages decoded by the communication protocol can then be acted on and/or routed by a handler object. The handler manages the actors and their associated activities. Messages intended for a specific actor are routed to the appropriate destination by the handler. Manipulation of the actor classes and management of agents are likewise controlled through the handler. Manipulation can include, but is not limited to, behavior model downloads, actor creation, and actor deletion.

The TrafficBot simulation creates one or more behavior profiles that specify behaviors that one wishes to simulate. The behavior profiles define actor classes, an instantiation of which comprises an actor. For example, behavior models can simulate the computer/network usage of a manager, an engineer, a clerk, a legal staff, and/or an automated backup system. Each of these compose a distinct actor class. For each actor class, a set of at least one activity is specified, for example, web browsing, e-mail, or FTP. Table 1 summarizes a list of activities for a hypothetical engineer actor class.

TABLE 1
Example of a list of activities in a behavior model for a hypothetical
engineer.

| Activity | Duration | Activity Volume | Event |
|---|---|---|---|
| Web Browsing | 8:00-14:00 | 5% | Downloading technical |
| | | | web pages |
| Web Browsing | 8:00-14:00 | 5% | Downloading general |
| | | | news web pages |
| E-mail Reading | 8:00-10:00 | 10% | Personal mailbox |
| E-mail Sending | 10:00-12:00 | 10% | Replying to e-mail |
| E-mail Sending | 12:00-17:00 | 3% | Request information |
| | | | from technical sites |
| FTP | 14:00-16:00 | 4% | Upload internal |
| | | | company data |

For each actor class and activity, an activity profile is defined that specifies an absolute target (e.g., URL or IP address) or a target class from which a specific target is selected during a simulation. The activity profile can further specify the mean and standard deviation activity volume by day of the week and time of day (e.g., events per minute of simulation time) and an activity-probability function. When the simulation is run, each activity will be simulated via an equation engine, which takes a seed value and the activity-probability function to provide a traffic rate value for each simulation delta-time. The target for the activities, which target can be a server or another actor, can be static. Alternatively, the target can be dynamically selected from a list of possible targets at runtime.

Once the actor classes have been created, one or more actors are instantiated on each hosted agent of the simulation environment. Each actor is given a name unique to its respective host and the name of an actor class that defines its behavior. The collection of actors compose the simulation community. Actors are responsible for the leveraging of its resources. Thus the creation and supervision of activity threads as well as the scheduling and timing of traffic are actor responsibilities. As described earlier, an example of an activity thread is a telnet session. Thus, the actor might open a telnet session, transmit some data files, and then close the session.

The simulation can be initiated through the controller by synchronizing the simulation clocks of all the agents and activating the actors. Specifically, the controller connects to all the agent hosts and downloads the behavior models and seed values for the simulation engine. Synthetic traffic flow is then synchronized to the simulation clock and can be modified from the system clock by a scaling factor. For example, a time-scale factor of one would result in the system clock time being equal to the simulation time. A time-scale factor of two would double the simulation time with respect to the system clock. Thus 24 hours of synthetic traffic would only take 12 hours to generate. The simulation time can also be fully independent from the system clock.

For each actor, the TrafficBot agents calculates whether or not a particular activity will occur during the current simulation time based upon parameters for the respective actor. If the activity occurs, the actor invokes the proper process (e.g., an e-mail client), connects with the appropriate server (e.g., a mail server), and initiates an event (e.g., send an email). A similar process occurs in every actor of the simulation community, thereby generating synthetic network traffic. The parameters used in the stochastic calculation can include the simulation delta-time, the receipt of network traffic from other actors, receipt of traffic from real users, network conditions, and/or the behavior model.

Agents can also be directed to collect host traffic metrics that allow visualization and control of the state of the network traffic. This allows TrafficBot users to verify that the simulated traffic corresponds with the actual generated traffic flows and identify problems due to system failures and network congestion in the real system and servers.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A method for generating synthetic network traffic comprising the steps of:
a. providing a behavior model to an agent through a controller;
b. operating the agent on a host, wherein the agent stochastically generates network traffic based on the behavior model; and
c. exchanging data between a server and the agent.

2. The method as recited in claim 1, wherein the operating step further comprises the steps of:
a. providing a simulation delta-time;
b. calculating whether an activity occurs during the simulation delta-time, wherein said calculating uses an activity-probability function for the activity and a pseudo-random number generator;
if the activity occurs, then the exchanging data step further comprises performing the following steps i-iv:
i. selecting a server for an event;
ii. establishing a link to the server;
iii. transferring data between the server and an actor; and
iv. terminating the link;
c. incrementing the simulation delta-time; and
d. returning to step b.

3. The method as recited in claim 2, wherein the returning step occurs for an elapsed simulation time less than a predetermined total simulation time.

4. The method as recited in claim 2, wherein the activity comprises at least one event.

5. The method as recited in claim 2, wherein the selecting step is stochastic or deterministic.

6. The method as recited in claim 2, wherein an actor executes the activity.

7. The method as recited in claim 6, wherein actors perform at least one activity.

8. The method as recited in claim 6, wherein the actor belongs to an actor class, said actor class comprising at least one activity profile.

9. The method as recited in claim 8, wherein the activity profile specifies operational schedules, activities, operational capabilities, activity-probability functions, or combinations thereof.

10. The method as recited in claim 8, wherein the activity profile is stochastic.

11. The method as recited in claim 6, wherein a community comprises at least one actor, wherein the actor comprises an instantiation of an actor class.

12. The method as recited in claim 2, wherein the activity-probability function comprises probability definitions for mean and standard-deviation events per simulation delta-time.

13. The method as recited in claim 1, wherein the data varies in size.

14. The method as recited in claim 6, wherein the size of the data is fixed or infinite

15. The method as recited in claim 1, wherein the synthetic network traffic is generated on a network comprising a serial network.

16. The method as recited in claim 1, wherein the synthetic network traffic is generated on a network comprising an Ethernet.

17. The method as recited in claim 1, wherein the synthetic network traffic is generated on a network comprising a wireless network.

18. The method as recited in claim 1, utilizing protocols selected from the group consisting of Supervisory Control And Data Acquisition (SCADA), HTTP, SMTP, TCP/IP, and combinations thereof.

19. The method as recited in claim 18, wherein the SCADA protocol is Modbus, Distributed Network Protocol Version 3.0 (DNP3), Conitel, IEC 60870-5-101, RP-570, or a combination thereof.

20. The method as recited in claim 1, wherein a host comprises at least one agent.

21. The method as recited in claim 20, wherein a controller manages at least one host.

22. The method as recited in claim 1, wherein management of the synthetic network traffic generation is controlled from a different subnet than that on which the synthetic network traffic is generated.

23. The method as recited in claim 1, further comprising the step of collecting traffic metrics through the agent.

24. The method as recited in claim 1, wherein a simulation clock is independent of a host system clock.

25. A system comprising:
a. An agent operating on a host, wherein the agent stochastically generates synthetic network traffic based on a behavior model.
b. A server exchanging data with the agent;
c. A controller providing the behavior model to the agent.

26. The system as recited in claim 25, wherein the system utilizes a plurality of software platforms.

27. The system as recited in claim 25, wherein the agent comprises at least one actor

28. The system as recited in claim 27, wherein the actor executes at least one activity according to the behavior model.

29. The system as recited in claim 27, wherein the actor is a member of an actor class

30. The system as recited in claim 25, wherein the data comprises controlled content.

31. The system as recited in claim 25, the data is random, static, accessed arbitrarily from a predefined data set, dynamically generated, or combinations thereof.

32. The system as recited in claim 25, wherein the server is a real server or an emulated server.

33. The system as recited in claim 25, wherein agents collect traffic metrics.

34. The system as recited in claim 25, further comprising a simulation clock independent of the host system clock.

35. The system as recited in claim 25, wherein the actor is capable of executing a plurality of activities substantially simultaneously.

36. The system as recited in claim 25, wherein the controller operates on a different subnet than that on which the synthetic network traffic is generated.

37. The system as recited in claim 25, wherein the synthetic network traffic is generated on a network comprising a serial network.

38. The system as recited in claim 25, wherein the synthetic network traffic is generated on a network comprising an Ethernet.

39. The system as recited in claim 25, wherein the synthetic network traffic is generated on a network comprising a wireless network.

40. The system as recited in claim 25, utilizing protocols selected from the group consisting of Supervisory Control And Data Acquisition (SCADA), HTTP, SMTP, TCP/IP, and combinations thereof.

41. The system as recited in claim 40, wherein the SCADA protocol is Modbus, Distributed Network Protocol Version 3.0 (DNP3), Conitel, IEC 60870-5-101, RP-570, or a combination thereof.
